(19) United States
(12) Patent Application Publication
(10) Pub. No.: US 2015/0305383 A1
(43) Pub. Date: Oct. 29, 2015

(54) PRETERM MILK FORMULA

(71) Applicants: Gilda Elise Georgi, Hosbach (DE); Bernd Stahl, Rosbach-Rodheim (DE)

(72) Inventors: Gilda Elise Georgi, Hosbach (DE); Bernd Stahl, Rosbach-Rodheim (DE)

(73) Assignee: N.V. NUTRICIA

(21) Appl. No.: 13/696,994

(22) PCT Filed: May 18, 2011
(86) PCT No.: PCT/EP2011/002493

§ 371 Date: Jan. 23, 2013

(30) Foreign Application Priority Data
May 18, 2010 (EP) PCT/EP2010/003027

(51) Int. Cl. A23L 1/29; A23C 9/20; A23L 1/305

(52) U.S. Cl. CPC A23L 1/296; A23L 1/3056; A23C 9/206; A23C 9/20; A23V 2002/00

(57) ABSTRACT

The present invention relates to a protein fortifier for use in varying the amount of protein in preterm infant nutrition, thereby adapting the formula or human milk to the nutritional needs of very low birth weight infants and extremely low birth weight infants.

### FIELD OF THE INVENTION

The present invention relates to nutritional supplements for premature infants.

### BACKGROUND TO THE INVENTION

The number of surviving children born with low birth weight has in-creased substantially during the last two decades. About 16% of infants born have a low birth weight. Said phenotype is caused either by premature birth (i.e. birth before the 37th week of gestation) and/or by in utero growth restriction in a small for gestational age (SGA) infant. The major goal of enteral nutrient supply to these infants is to achieve growth similar to fetal growth coupled with satisfactory functional development.

Many infant formulae for term infants are available on the market. However, these are not optimal for administration to infants with a low birth weight, since the complete nutritional needs of a rapidly growing infant is not met. Likewise, the composition of human milk does not meet the nutritional requirements. The preferred food for infants with a low birth weight is therefore fortified human milk, or, alternatively, formula specially designed for these infants. Human milk fortifiers (HMF) and preterm infant formulae are commercially available. Typically, HMF comprises besides protein, also carbohydrates or fat, minerals and vitamins. Typically, preterm infant formulae have an increased protein concentration.

WO 96/29881 describes foods for premature babies and infants and dietetic foods as well as a process for their production based on the milk, milk constituents and milk products of mammals. The foods contain some or all of the albumin and beta-lactoglobulin in the form of monomers. The ratio of alpha-lactalbumin to beta lactoglobulin is improved with respect to the milk of ruminants. The foods contain at least the same amount of beta-casein as alpha-s-casein.

WO 03/028763 relates to a method of administering a dietary supplement to a human infant, comprising administering to the human infant human breast milk and administering to the human infant a supplement which is essentially free of carbohydrate comprising an additive selected from the group consisting of casein, salts of casein, whey, and hydrolysates of casein.

WO 2008/119163 relates to a multi-nutrient fortifier for supplementing a breastfed infant, in particular a low birth weight infant, a postsurgical infant, or an ill term-born infant.

However, the formulations and methods to use them to provide the required nutrition to preterm infants usually still do not take into ac-count the desired and required calorie and protein demands of the preterm infants, in particular not in an easy and cost-effective manner.

Thus, the technical problem underlying the present invention is to provide a simple and cost-efficient system for feeding a preterm infant enabling a growth similar to fetal growth of the infant which system is particularly applicable to a wide range of different preterm infants, in particular to preterm infants in a wide range of body weights.

### SUMMARY OF THE INVENTION

In one aspect, the present invention relates to a kit for use in providing a nutrition to preterm infants, wherein the protein and calorie amount of said nutrition is adapted according to the body weight of the infant comprising

a) a basic nutritional composition and

b) a protein fortifier which comprises at least 50% protein based on total calories of the protein fortifier and at least 50 wt % protein based on dry weight of the protein fortifier, wherein the basic nutritional composition is a fortified human milk or a preterm infant formula.

In one embodiment, the infants are selected from the group consisting of low body weight infants, very low body weight infants and extremely low body weight infants.

In another embodiment, the protein fortifier comprises at least 70% protein based on total calories of the protein fortifier and at least 70 wt % protein based on dry weight of the protein fortifier.

In another embodiment, the protein fortifier comprises casein and whey protein.

In yet another embodiment, the protein fortifier comprises a protein with a degree of hydrolysis from 3 to 20%.

In another embodiment, the protein fortifier, the basic nutritional composition or both is or are present in form of a unit dose.

In another embodiment, the kit comprises additionally c) instructions for adding at least a portion of the protein fortifier to the basic nutritional composition. In another embodiment, the instructions comprise instructions to add the protein fortifier to the basic nutritional composition in such an amount that the amount of protein present in the fortified nutritional composition is one or more selected from the group consisting of:

i) 14% to 16% based on total calories for administration to infants with a body weight of <1000 g,

ii) 12% to less than 14% based on total calories for administration to infants with a body weight of 1000 to 1800 g and

iii) up to 12% based on total calories for administration to infants with a body weight of >1800 to 2500 g.

In yet another embodiment, the instructions comprise instructions to add the protein fortifier to the basic nutritional composition in such an amount that the amount of protein to be administered to the preterm infant is one or more selected from the group consisting of i) 4.0 to 4.5 g protein per kg body weight per day for administration to infants with a body weight of <1000 g, ii) 3.5 to less than 4.0 g protein per kg body weight per day for administration to infants with a body weight of 1000 to 1800 g and iii) 2.0 to 3.4 g protein per kg body weight per day for administration to infants with a body weight of more than 1800 to 2500 g.

In another aspect, the invention relates to a protein fortifier for use in providing in combination with an infant nutritional composition a nutrition to preterm infants, wherein the protein and calorie amount of said nutrition is adapted according to the body weight of the infant wherein the protein fortifier comprises at least 50% protein based on total calories of the protein fortifier and at least 50 wt % protein based on dry weight of the protein fortifier and wherein the infant nutritional composition is a basic nutritional composition, namely a fortified human milk or a preterm infant formula.

In one embodiment, the protein fortifier comprises at least 70% protein based on total calories of the protein fortifier and at least 70 wt % protein based on dry weight of the protein fortifier.

In another aspect, the invention relates to a container comprising a protein fortifier as described above for use in providing a nutrition to preterm infants, wherein the protein and calorie amount of said nutrition is adapted according to the body weight of the infant, which is in the form of a powder and is present in an amount of from 0.05 g to 500 g per container, wherein the container comprises instructions for adding at least a portion of said protein fortifier to an infant nutritional composition, namely a preterm infant formula or a fortified human milk.

In another embodiment, the invention relates to a container comprising a protein fortifier, as described above, for use in providing a nutrition to preterm infants, wherein the protein and calorie amount of said nutrition is adapted according to the body weight of the infant, wherein the protein fortifier is present in the form of a powder or in the form of a sterilized liquid with a volume of 0.5 ml to 70 ml and a protein concentration of at least 0.05 g/ml, more preferably at least 0.1 g/ml, wherein the container comprises instructions for adding at least a portion of said protein fortifier to an infant nutritional composition, namely a preterm infant formula or a fortified human milk.

In another aspect, the invention relates to a method of providing nutrition to a preterm infant, comprising administering a protein fortifier comprising at least 50% protein based on total calories of the protein fortifier and at least 50 wt % protein based on dry weight of the protein fortifier, wherein the protein fortifier is added to an infant nutritional composition in such an amount that the amount of protein present in the fortified infant nutritional composition is selected from one or more of the group consisting of:

i) 14% to 16% based on total calories for administration to infants with a body weight of <1000 g,

ii) 12% to less than 14% based on total calories for administration to infants with a body weight of 1000 to 1800 g and

iii) up to 12% based on total calories for administration to infants with a body weight of >1800 to 2500 g and wherein the infant nutritional composition is a fortified human milk or a preterm infant formula.

In another embodiment of the methods of the invention, the fortified infant nutritional composition is in such an amount that the amount of protein administered is selected from one or more of the group consisting of: i) 4.0 to 4.5 g protein per kg body weight per day for administration to infants with a body weight of <1000 g, ii) 3.5 to less than 4.0 g protein per kg body weight per day for administration to infants with a body weight of 1000 to 1800 g and iii) 2.0 to 3.4 g protein per kg body weight per day for administration to infants with a body weight of more than 1800 to 2500 g.

In another embodiment, the methods of the invention comprise the steps of:

xa) fortifying an infant nutritional composition with protein by adding to it the protein fortifier described above and

xb) administering to said infant the fortified infant nutritional composition obtained in step xa), wherein the protein fortifier is added to the infant nutritional composition in such an amount that the amount of protein present in the fortified infant nutritional composition is one or more selected from the group consisting of:

i) 14% to 16% based on total calories for administration to infants with a body weight of <1000 g,

ii) 12% to less than 14% based on total calories for administration to infants with a body weight of 1000 to 1800 g and

iii) up to 12% based on total calories for administration to infants with a body weight of >1800 to 2500 g and wherein the infant nutritional composition is a fortified human milk or a preterm infant formula.

In another embodiment of the methods of the invention, the fortified infant nutritional composition is administered to said infant in such an amount that the amount of protein administered is one or more selected from the group consisting of:

i) 4.0 to 4.5 g protein per kg body weight per day for administration to infants with a body weight of <1000 g,

ii) 3.5 to less than 4.0 g protein per kg body weight per day for administration to infants with a body weight of 1000 to 1800 g and

iii) 2.0 to 3.4 g protein per kg body weight per day for administration to infants with a body weight of more than 1800 to 2500 g.

### DETAILED DESCRIPTION OF THE INVENTION

Preterm infants with a low weight, in particular low birth weight, are not a uniform group with similar nutritional needs. In fact, within this group several subgroups exist defined in their nutritional needs inter alia by their body weight. In the context of the present invention it was recognized that the need for dietary protein is increased in preterm infants with a very low or extremely low body weight compared to low weight preterm infants with a higher body weight. However, a too high protein intake resulting in a too fast growth of the infant may increase the risk of obesity later in life. Furthermore, a too protein-rich nutrition requires a higher urea excretion in urine and represents a burden to the kidney of an infant. The caloric need, on the other hand, is lower in preterm infants with a very low or extremely low body weight compared to low weight preterm infants with a higher body weight. In particular and in a preferred embodiment of the present invention, the inventors based their invention inter alia on the definition of at least two, preferably three, subgroups of preterm infants all of these groups having a low body weight, in particular low birth weight, wherein a first group of preterm infants have a low body weight, in particular lower than average term infants, and a second group of preterm infants have a low body weight which is even below the body weight of said first group of preterm infants. Preferably, the first group of preterm infants have a body weight from above 1800 g, e. g. 1810 g, to about 2450 to 2500 g, preferably less than 2500 g (in particular so called LBW infants, low birth weight infants) and the second group of preterm infants have a body weight up to 1800 g. Most preferably, said second group of infants can further be divided into a group of infants with very low body, in particular birth, weight from preferably 1000 to about 1790 to 1800 g, in particular 1800 g (in particular so called VLBW infants, very low birth weight infants) and a group of preterm infants which have an extremely low body, in particular birth, weight preferably less than 1000 g (in particular so called ELBW infants, extremely low birth weight infants). Although compared to term infants the need for dietary protein is increased in all preterm infants with a low body weight, the protein need is higher in very low body weight (in particular VLBW) and highest in extremely low body weight (in particular ELBW) infants, compared to low body weight infants. The caloric need, on the other hand, is lower in very low body weight infants and lowest in extremely low body weight infants, compared to low body weight infants. Hence, the uniform preterm infant formula or human milk fortifiers of the prior art are not tailored for the specific needs of these subgroups, with either the protein concentrations administered being too low in very low body weight infants or extremely low body weight infants, when adequate calories are administered, and/or the protein concentrations administered being too high especially for low body weight infants with a body weight above 1800 g, when adequate calories are administered.

Thus, the present invention solves its underlying problem by providing a kit of parts for use in providing a protein and/or calorie adapted body weight dependent nutrition to preterm infants comprising a) a basic nutritional composition and b) a protein fortifier which comprises at least 50% protein based on total calories of the protein fortifier and at least 50 wt % protein based on dry weight of the protein fortifier.

Thus, the present invention provides a kit particularly useful for feeding preterm infants with a low body weight, for instance at birth, preferably below about 2500 g, comprising at least two different and separate elements, namely a basic nutritional composition and a protein fortifier. The basic nutritional composition is suitable and pre-pared to provide a sufficient and full nutrition to preterm infants constituting a first group of preterm infants, with, in comparison to term infants, low body weight, in particular a body weight above a thresh-old value in a range of 1700 to 1900 g, in particular above 1800 g, up to about 2500 g. Said basic nutritional composition provides all macro- and micronutrients to achieve satisfactory preterm infant growth and development for such a preterm infant. In addition, the kit of the present invention provides a protein fortifier suitable and prepared to be used in combination with the above identified basic nutritional composition in order to provide a protein and/or calorie adapted nutrition to preterm infants constituting a second group of preterm infants, which takes into account the body weight dependence of the protein and calorie needs for the preterm infants having an even lower body weight than the first group.

The present invention relates to products, uses of the products and methods for feeding preterm infants with a body weight of less than about 2500 g, preferably selected from the group consisting of low body weight infants, preferably LBW infants, very low body weight infants, preferably VLBW infants and extremely low body weight infants, preferably ELBW. In a preferred embodiment of the present invention low body weight infants have a weight of preferably more than 1800 g, preferably 1810 g, to about 2500 g, preferably to less than 2500 g, in particular to 2490 g. Very low body weight infants have a weight of preferably 1000 to 1800 grams. Extremely low body weight infants have preferably a body weight less than 1000 grams, preferably less than 990 g.

In the context of the present invention the expression post-discharge infant means a preterm infant being discharged from a hospital, that means relates to a preterm infant which is in the phase immediately after discharge from a hospital up to the time point at which the preterm infant has gained the weight of a term infant. Thus, a post-discharge infant formula in the context of the present invention is a particular form of a preterm infant formula of the present invention.

Infants with a low, very low and extremely low body weight, in particular LBW, VLBW and ELBW infants, include premature infants and/or small for gestational age (SGA) babies. A premature or pre-term infant relates to an infant born before the standard period of pregnancy is completed before or on 37 weeks pregnancy of the mother, i.e. before or on 37 weeks from the beginning of the last menstrual period of the mother. SGA babies are those whose birth weight lies below the 10th percentile for that gestational age. They have usually been the subject of intrauterine growth restriction.

LBW, VLBW and ELBW infants have special nutritional needs, and especially an increased need for proteins, to support the growth. Furthermore, a suboptimal intake of protein, energy, and other nutrients may lead to lower cognitive achievements.

The present invention solves its problem in particular by providing a kit of parts, hereinafter also termed a “kit”, for use in providing a protein- and/or calorie-adapted body weight dependent nutrition to infants, preferably to preterm infants, preferably with a body weight of at most 2500 g, preferably less than 2500 g, comprising a) a basic nutritional composition, preferably present in at least one first container, and b) a protein fortifier, preferably present in at least one second container, which protein fortifier comprises at least 50% protein based on total calories of the protein fortifier and at least 50 wt. % protein based on dry weight of the protein fortifier.

The present invention solves the problem in particular by providing a kit of parts for use in providing nutrition to infants selected from the group consisting of low body weight infants, very low body weight infants and extremely low body weight infants, preferably selected from the group consisting of very low body weight infants and extremely low body weight infants, comprising a) a basic nutritional composition and b) a protein fortifier which comprises at least 50% protein based on total calories of the protein fortifier and at least 50 wt % protein based on dry weight of the protein fortifier, wherein said kit is equally useful for the optimal nutrition of one, two or all of the above-identified body weight subgroups.

The kit of parts and the other embodiments of the present invention, such as protein fortifiers or methods of using the kit and protein fortifier, are preferably intended for use in providing nutrition to preterm infants having a low body weight, in particular a weight from below 1000 g, e. g. 400 g, up to 2500 g, preferably selected from the group consisting of low body weight infants, preferably LBW infants, very low body weight infants, preferably VLBW infants, and extremely low body weight infants, preferably ELBW infants. The expression “intended” means that the kit of parts and the other embodiments of the present invention are suitable, in particular are suitable and pre-pared, for use in providing nutrition to preterm infants having a low body weight, in particular a weight from below 1000 g, e. g. 400 g, up to 2500 g, preferably for low body weight infants, very low body weight infants or extremely low body weight infants, more preferably to all three subgroups, preferably for very low body weight infants and extremely low body weight infants. Such an intention is preferably evidenced by instructions, preferably written instructions, accompanying the kit, method or protein fortifier of the present invention.

The expression “a protein and/or calorie adapted body weight de-pendent nutrition” means that the nutrition of a preterm infant is de-signed and prepared in such a manner that the protein and/or calorie needs of the infant to be fed is determined in dependency upon its body weight and that the nutrition to be administered contains exactly and specifically said determined protein and/or calorie content. Such an “adapted body weight dependent nutrition” of the present invention takes preferably the following into account: Infants have an increased need for protein and a decreased need for calories with decreased body weight. On the other hand, preterm infants who do not require a nutrition with an increased protein content such as preterm infants having a comparable higher body weight, should not obtain such a nutrition to avoid the risk of obesity and to save the kidney. These higher weight preterm infants require a comparable higher content of calories in their nutrition. Due to the present separation of the nutrition components in a basic nutritional composition and a separate protein fortifier the present invention allows the best possible adaption of the nutrition to particularly low, very low and extremely low body weight infants, preferably LBW, VLBW and or ELBW infants, in view of their protein and calories requirements. The total calories administered to an infant can easily be adapted to the need of the infant by the amount of the basic nutritional composition administered per day, preferably, depending upon the specific infant's need, and preferably fortified with the protein fortifier of the present invention. In particular, varying the amount of the basic nutritional composition in relation to the amount of the protein fortifier in the final nutrition dose administered to the premature infant allows a weight dependent variation of calorie and protein uptake of the preterm infant and therefore provides a considerably improved nutrition of said infants in terms of health and growth. The amount of protein administered to an infant can easily be adapted to the need of the infant by the amount of the protein fortifier added to the basic nutritional composition administered per day. Accordingly, it is possible to use the kit of parts according to the present invention to provide a nutrition containing an high amount of protein and a low amount of total calories, suitable e.g. for infants with a very low or extremely low body weight, for instance a body weight of less than 1000 g, by adding a high amount of the protein-rich protein fortifier to a low amount of the comparable protein-poor basic nutritional composition. Importantly, it is also possible to use the same kit of parts according to the present invention to provide a nutrition containing a smaller amount of protein and a higher amount of total calories, suitable e.g. for infants with a body weight of above 1800 g, in particular more than 1800 g to less than 2500 g, preferably 2490 g, by adding a smaller amount of the protein fortifier to a higher amount of the basic nutritional composition.

In the context of the present invention the term “protein- and/or calorie-adapted bodyweight dependent nutrition” preferably refers to a nutrition whose protein, whose calorie or whose protein and calorie amount is adapted according to the bodyweight of the consumer of said nutrition, which means that said nutrition is designed and suit-able for a nutrition of humans, in particular preterm infants, taking into account the demands for protein, for calorie or for protein and calories in dependency upon the bodyweight of said preterm infant. Accordingly, the term “a protein- and/or calorie-adapted bodyweight dependent nutrition” preferably provides the teaching to specifically use the kit or protein fortifier of the present invention for a specific calorie, protein or calorie and protein dosage regimen in dependency upon the bodyweight of the preterm infant. Said adaption is achieved according to the present invention preferably by using at least two components of a kit, namely a basic nutritional composition and a protein fortifier, for a combined and additive administration to the preterm infant, wherein the specific protein and/or calorie demands of the specific preterm infant are met by adapting the ratio of the administered amounts of said components according to the bodyweight of the specific preterm infant.

In the context of the present invention the term “protein” preferably refers to any oligo-or polypeptide(s), in particular to oligo- or poly-peptides suitable for human nutrition, in particular polypeptides suit-able for human nutrition. Preferably, the proteins are milk-derived proteins, for instance caseins or whey protein. In the context of the present invention the term “kit” preferably refers to a system comprising at least two different elements, in particular two different compositions, which are to be used together either simultaneously or subsequently in order to fulfil a common purpose together, in particular to provide an improved nutrition to preterm infants together. Thus, a kit according to the present invention preferably is composed out of at least two elements, in particular compositions, and therefore is also termed herein as “a kit of parts”. Preferably, the elements or parts of the kits are assembled in a single package, which may contain the different elements in separate containers.

In a preferred embodiment of the invention the kit comprises additionally c) instructions, preferably written instructions, for instance in form of an instruction leaflet or a package label. In a preferred embodiment of the invention the kit comprises additionally c) instructions for adding at least a portion of the protein fortifier to the basic nutritional composition, preferably so as to increase the protein concentration of the obtained fortified nutritional composition in order to adapt said fortified nutritional composition for administration to low body weight preterm infants with a body weight up to 1800 g.

In a preferred embodiment of the invention the instructions comprise, preferably detailed, written instructions to add the protein fortifier to the basic nutritional composition in such an amount that the amount of protein present in the fortified nutritional composition is one or more selected from the group consisting of: i) 14% to 16% based on total calories for administration to infants with a body weight of <1000 g, ii) 12% to less than 14% based on total calories for administration to infants with a body weight of 1000 to 1800 g and iii) up to 12%, preferably up to 11.9%, based on total calories for administration to infants with a body weight of >1800 up to 2500 g.

According to a preferred embodiment of the invention the fortified preterm infant formula or fortified human milk is for ii) 12% to 13.9%, even more preferably 12% to 13,5% based on total calories for administration to infants with a body weight of 1000 to 1800 g.

In a preferred embodiment of the invention the instructions comprise, preferably detailed, written instructions to add the protein fortifier to the basic nutritional composition in such an amount that the amount of protein present in the fortified nutritional composition is one or more selected from the group consisting of i) 3.6 g to 4.1 g per 100 kcal contained in the fortified nutritional composition for administration to infants with a body weight of <1000 g, ii) 3.2 g to less than 3.6 g per 100 kcal contained in the fortified nutritional composition for administration to infants with a body weight of 1000 to 1800 g and iii) up to 3 g per 100 kcal contained in the fortified nutritional composition, more preferably 2.2 g to 2.8 g per 100 kcal contained in the fortified nutritional composition for administration to infants with a body weight of >1800 up to 2500 g.

According to a preferred embodiment of the invention the protein amount in the fortified preterm infant formula or fortified human milk is for ii) 3.2 g to 3.59 g, even more preferably 3.2 g to 3.5 g, per 100 kcal contained in the fortified nutritional composition for administration to infants with a body weight of 1000 to 1800 g.

In a preferred embodiment of the invention the instructions comprise, preferably detailed, written instructions to add the protein fortifier to the basic nutritional composition in such an amount that the amount of protein present in the fortified nutritional composition is preferably as indicated above, and most preferably the fortified nutritional composition is intended for administration to preterm infants in such an amount that the amount of protein is one or more selected from the group consisting of: i) 4.0 to 4.5 g protein per kg body weight per day for administration to infants with a body weight of <1000 g, ii) 3.5 to less than 4.0 g, preferably to 3.9 g, protein per kg body weight per day for administration to infants with a body weight of 1000 to 1800 g and iii) 2.0 to 3.4 g protein per kg body weight per day for administration to infants with a body weight of more than 1800 up to 2500 g. Furthermore, in a preferred embodiment of the present invention the kit comprises further instructions, in particular written instructions, so as to adapt the amount and/or volume of the basic nutritional composition in relation to the amount of protein fortifier used for the preparation of the fortified nutritional composition in dependency upon the caloric need of the preterm infants to be fed.

For example, the written instructions of the kit or the protein fortifier according to the present invention relate and explicitly refer to the preferred embodiments of the present invention.

Preferred embodiments relate inter alia to the addition of the protein supplement or fortifier to standard HMF fortified human milk, that means human breast milk, in particular preterm human breast milk or to preterm formula in order to achieve a protein level which covers the need of extremely low birth weight infants to ensure good growth and development. For preterm babies with a body weight <1000 g a protein intake of 3.6-4.1 g/100 kcal, in particular 4.0-4.5 g/kg/d, is preferred. That means, if in a preferred embodiment preterm human milk, for instance with a protein content of about 1.5 g/100 ml, in particular 2.3 g/100 kcal, is used, first, standard HMF is added according to the given instructions. Then, preferably the appropriate amount of the protein supplement according to the present invention is added to achieve the recommended level of protein of 3.6-4.1 g/100 kcal for ELBW. To adjust the protein level of a preterm formula to a preferred value of 3.6-4.1 g/100 kcal, in particular 4.0-4.5 g/kg/d, 0.4 g to 0.9 g protein supplement per 100 ml preterm formula may be added, in particular if the preterm formula contains 3.3 g protein/100 kcal, in particular 2.6 g/100 ml.

In a preferred embodiment of the invention the kit comprises additionally d) a measuring device, preferably pipette, ampoule, droplet applicator, dispenser, preferably tablet dispenser, a measuring cup, syringe, bottle or spoon. The measuring device has preferably a scale which allows measuring the exact amount of the protein fortifier which shall be added to the basic nutritional composition.

### Infant Nutritional Compositions

In the context of the present invention an infant nutritional composition is a nutritional composition suitable and prepared for the nutrition of infants. In particular, an infant nutritional composition is suitable and prepared for the nutrition of preterm infants, including post-discharge infants, and term infants. Thus, the expression infant nutritional composition as used herein encompasses also nutritional compositions specifically adapted for term infants. The expression infant nutritional composition also encompasses basic nutritional compositions. Thus, an infant nutritional composition preferably is a preterm infant formula, human milk or term infant formula. Preferably, the infant nutritional composition is a preterm infant formula or human milk.

The infant nutritional composition may in a preferred embodiment be a human milk. In a furthermore preferred embodiment the infant nutritional composition may be a synthetic infant formula, in particular a preterm infant formula, a post-discharge infant formula or a term infant formula.

### Basic Nutritional Composition

In the context of the present invention a basic nutritional composition is a nutritional composition suitable and prepared for the nutrition of preterm infants. In particular, a basic nutritional composition comprises all macro- and micronutrients needed for preterm infants so as to achieve a growth similar to fetal growth coupled with satisfactory functional development. Thus, a basic nutritional composition used in the present invention is suitable and prepared for providing a sufficient and full nutrition of preterm infants with a low body weight which, however, is not very or extremely low, in particular is above 1700 to 1900 g, in particular above 1800 g, preferably from 1810 g body weight up to preferably 2500 g.

In a preferred embodiment of the invention the basic nutritional composition is a human milk or a preterm infant formula. In a preferred embodiment of the invention the basic nutritional composition is human milk or a human milk fortified with a standard human milk fortifier. In a preferred embodiment, the human milk may be fortified with a human milk fortifier and represents in this fortified form the presently used basic nutritional composition. Thus, the basic nutritional com-position of the present invention can be fortified human milk. That means, if the basic nutritional composition according to the present invention is human milk, also human milk already fortified with a human milk fortifier, in particular conventional or standard milk fortifier, can be used as basic nutritional composition, which then can be further fortified with the protein fortifier according to the present invention to achieve a nutrition for preterm infants whose protein and/or calorie content is adapted to the bodyweight of the infant to be fed. A standard human milk fortifier (HMF) typically has a protein content of less than 50%, preferably less than 40%, more preferably less than 35 wt %, even more preferably below 30% based on total calories.

In a preferred embodiment of the invention the basic nutritional com-position is a preterm infant formula, preferably a conventional pre-term infant formula. In a preferred embodiment of the invention the preterm infant formula is a synthetic preterm infant formula.

In a preferred embodiment of the invention the basic nutritional com-position is for an enteral use.

The basic nutritional composition is preferably in dry, preferably powdered, or liquid form. The basic nutritional composition is preferably in unit dose form. Preferably, the basic nutritional composition is present in a container, preferably containing one single or more unit dose(s).

The basic nutritional composition has preferably a protein content below that of the protein fortifier used in the present kit. In a particularly preferred embodiment of the present invention the basic nutritional composition used in the present kit has a calorie content which is above the calorie content of the protein fortifier of the present kit.

In a particularly preferred embodiment the basic nutritional composition comprises from 0.5 to 25 wt %, preferably 5 to 25 wt % protein, preferably 9 to 20 wt %, most preferably 12 to 18 wt % protein based on the dry weight of the basic nutritional composition. In a particularly preferred embodiment the basic nutritional composition in dry form, particularly powdered form, comprises from 100 to 800 kcal/100 g, preferably 200 to 700 kcal/100 g, preferably 300 to 600 kcal/100 g, preferably 400 to 500 kcal/100 g, preferably 470 to 490 kcal/100g and most preferably 474 or 485 kcal/100 g (based on total weight of nutritional composition in dry form, particularly powdered form).

A preterm infant formula has in a preferred embodiment about 70 to 90 kcal, preferably 80 kcal, per 100 ml and about 1.8 to 3.0, preferably 2.0 to 3.0 g, preferably 2.5 g to 2.6 g protein, per 100 ml, preferably casein and whey protein from cow's milk. Furthermore and in a preferred embodiment, such a preterm infant formula may also comprise about 3.5 to 5.5 g, preferably 3.9 to 4.4 g, fat per 100 ml, usually vegetable fat, preferably medium chain triglycerides up to 40% of the total fat, and long chain poly-unsaturated fatty acids, in particular arachidonic acid and docosahexaenoic acid, about 7.0 to 9.6, preferably 7.0 to 8.5 g, preferably 7.5 to 8.4 g, carbohydrates per 100 ml, usually lactose and polysaccharides, vitamins, mineral, trace elements, L-carnitine, choline, myo-inositol, taurine and optionally nu-cleotides and non-digestible oligosaccharides. Compared to term infant formula, such preterm infant formulae have higher concentrations of protein, fat, minerals, trace elements, and vitamins.

### Protein Fortifier

The present invention solves its underlying technical problem also by the provision of a protein fortifier for use in providing, in particular in combination with an infant nutritional composition, preferably in combination with a basic nutritional composition, a protein and/or calorie adapted body weight-dependent nutrition to preterm infants, wherein the protein fortifier comprises at least 50%, at least 70%, at least 80% and preferably at least 90% protein based on total calories of the protein fortifier and at least 50 wt %, at least 70 wt %, preferably at least 80 wt % and most preferably at least 90 wt % protein based on dry weight of the protein fortifier. In a particularly preferred embodiment the protein fortifier is for use in providing nutrition to preterm infants in combination with a basic nutritional composition of the present invention. However, the protein fortifier of the present invention is also for use in providing a protein and/or calorie adapted body weight-dependent nutrition to preterm, including post-discharge, infants in combination with an infant nutritional composition, such as a human milk, a preterm infant formula, a post-discharge infant formula or a term infant formulation.

In the context of the present invention the expression “in combination with” means that the protein fortifier of the present invention is suitable and prepared to be administered together with an infant nutritional composition, preferably a basic nutritional composition, of the present invention so as to achieve in the preterm infant the desired nutritional effects. Accordingly, the expression “in combination with” preferably means that the protein fortifier of the present invention being provided separately from the infant nutritional composition, for instance in a separate container, and the infant nutritional composition, also being provided in a separate container, are mixed shortly or immediately prior to administration and are given to the infant in need thereof. In a preferred embodiment of the present invention the protein fortifier of the present invention comprises instructions so as to combine it with an infant nutritional composition, in particular a basic nutritional composition. Preferably, the instructions are detailed written instructions indicating preferably that the protein fortifier is for providing a protein and/or calorie adapted body weight-dependent nutrition in combination with the infant nutritional composition.

The protein fortifier of the present invention, which is used preferably in the kit of parts or in a unit dose, is preferably used to supplement infant nutritional composition, preferably for instance standard preterm infant formulae, which are preferably used as basic nutritional composition.

Preferably, the addition of the protein fortifier to a preterm infant formula or to human milk, possibly in one embodiment of the present invention already supplemented with a commercial breast milk fortifier, results in a range of fortified basic nutritional compositions, preferably of fortified preterm infant formulae or fortified human milk, with increasing protein concentration suitable for infants with decreasing body weight. Such a range is for example a preterm infant formula comprising 14 to 16% protein based on total calories intended for administration to infants with a body weight <1000 g, a preterm infant formula comprising 12 to less than 14% protein based on total calories intended for administration to infants with a body weight from 1000 to 1800 g, and a preterm infant formula comprising up to 12%, preferably up to 11.9%, protein or less based on total calories intended for administration to infants with a body weight >1800 g.

The present protein fortifier preferably comprises at least 50% protein, more preferably at least 70%, even more preferably at least 80%, and in particular at least 90% protein based on total calories of the protein fortifier.

Thus, at least 50%, preferably 70%, preferably 80% and most preferably 90% of the total calories of the protein fortifier are provided in form of proteins. The wording “% protein based on total calories” refers to the energy of 1 g protein being about 4.0 kcal.

Preferably, the present protein fortifier comprises not more than 94% protein more preferably not more than 93% and particularly preferred not more than 92% based on total calories of the protein fortifier.

Preferably, the protein fortifier comprises at least 50% wt % protein, more preferable at least 60 wt % or at least 70 wt %, even more preferably at least 80 wt % protein based on dry weight of the protein fortifier. Preferably, the protein, most preferably at least 90 wt % protein, fortifier does not comprise more than 94 wt. %, more preferably not more than 93 wt. %, most preferably not more than 92 wt % protein based on dry weight of the protein fortifier.

For determining the amount of protein, the sum of proteins, peptides and free amino acids should be taken into account. Preferably, the protein content is determined according to the Kjeldahl method by measuring total nitrogen and using a conversion factor of 6.38, preferably in case of casein, or a conversion factor of 6.25 for other proteins.

In a preferred embodiment of the invention the protein fortifier comprises not more than 95 wt % protein based on dry weight of the protein fortifier and not more than 95% protein based on total calories of the protein fortifier. In a preferred embodiment of the invention the protein fortifier comprises not more than 95 wt % protein based on dry weight of the protein fortifier. In a preferred embodiment of the invention the protein fortifier comprises not more than 95% protein based on total calories of the protein fortifier.

The present protein fortifier contains protein, preferably in an amount of 50 to 95 wt %, preferably 55 to 95 wt %, most preferably 60 to 95 wt % and particularly preferred 60 to 90 wt % protein (based on dry weight of the protein fortifier).

Preferably, the protein is a highly soluble and/or stable protein. Most preferably, the protein is human milk protein, cow milk protein or soy protein, preferably soy bean protein, or a combination thereof. Preferably, the protein is casein, whey protein or both. Most preferably, the protein is present in isolated and purified form.

In a preferred embodiment of the invention the protein fortifier comprises casein and whey protein. In a preferred embodiment of the invention the protein fortifier comprises casein. In a preferred embodiment of the invention the protein fortifier comprises whey protein.

Preferably, the protein fortifier comprises whey protein and/or casein derived from human or non-human milk, preferably cow's milk. Preferably, the weight ratio (based on dry weight) of casein to whey protein is from 80/20 to 20/80, more preferably from 40/60 to 50/50. Whey protein is highly suitable as a protein source for preterm infants with a low body weight. However, since sweet whey protein generally has a high threonine content, which can result in hyperthreoninemia, the present composition preferably comprises acid whey protein or sweet whey protein from which at least part of the glycomacropeptide (GMP) is removed. The present protein fortifier preferably contains from 4.7 to 7.5 g threonine per 100 g amino acids, preferably from 3.9 to 4.6 g threonine per 100 g amino acids.

Preferably, the protein fortifier comprises acid whey protein or GMP-free or GMP-reduced sweet whey protein, disclosed and incorporated herein by reference to its composition and preparation for in-stance in WO1994EP04209 and casein, preferably in order to pro-vide an optimal amino acid profile.

The present protein fortifier preferably contains non-hydrolysed intact protein, protein hydrolysate and/or amino acids. Preferably, the present protein fortifier contains non-hydrolysed protein, in order to decrease the osmolarity of the reconstituted preterm infant formula or human milk, which is essential in LBW infants, especially in VLBW and ELBW infants. Advantageously, the protein of the present protein fortifier is hydrolysed in order to increase digestibility and tolerance. This is particularly preferred in LBW infants and in particular in VLBW and ELBW infants since they have an immature intestinal tract which impaired digestion and absorption capacity. Advantageously and preferably, the protein is present in the protein fortifier in partially hydrolyzed form, thereby enabling a better solubility and digestion than intact protein, without increasing the osmolarity too much, as is the case with extensively hydrolysed protein or free amino acids. Partially hydrolyzed protein in this invention refers to protein with a degree of hydrolysis from 3 to 20%.

In a preferred embodiment of the invention the protein fortifier comprises a protein with a degree of hydrolysis from 3 to 20%, preferably 5 to 18%, most preferably 5 to 15%. In a preferred embodiment of the invention the protein fortifier is pre-sent in form of a unit dose, preferably in a unit dose according to the present invention.

Preferably, the present protein fortifier is present in a container, preferably together with instructions to use it according to the present invention. Preferably, the container contains one single or more unit dose(s). In a preferred embodiment of the present invention the container of the present invention comprising the protein fortifier is for use in providing a protein- and/or calorie-adapted bodyweight de-pendent nutrition to preterm infants.

Preferably, the present protein fortifier is present in dry form, preferably in powdered form. Preferably, the present protein fortifier is pre-sent in powdered form in a suitable container, preferably packed in tins or sachets. The protein fortifier may in a preferred embodiment also be present in the form of a pressed powder, in particular a pill or tablet. The protein fortifier can preferably also be present in liquid form, preferably in the form of a sterilized, liquid concentrate in unit dose, preferably small unit doses. The protein fortifier may in a preferred embodiment also be present in liquid form in a dropping bottle, ampoule, syringe or pipette.

In a preferred embodiment of the invention the protein fortifier does not contain sodium carbonate.

The present fortified infant nutritional composition, preferably fortified basic nutritional composition, preferably fortified preterm milk, when fortified with the present protein fortifier preferably has an osmolarity from 300 to 500 mOsm/l, preferably 300 and 400 mOsm/l, most preferably 320 to 380 mOsmol/l, preferably 350 mOsmol/l.

Preferably, the osmolarity of an infant nutritional composition, preferably basic nutritional composition, preferably preterm infant formula, is about 280 to 350 mOsmol/l. Preferably, the caloric density of the fortified basic nutritional composition, preferably the fortified preterm infant formula or the fortified human milk, is between 70 and 85 kcal/100 ml, more preferably between 78 and 83 kcal/100 ml.

### Unit Dose

In the context of the present invention an unit dose is the amount of a composition administered to an infant in a single dose. A unit dose packaging is the packaging of a single dose in a suitable container, in particular a non-reusable container.

The present invention relates also to a unit dose, preferably present in a container, comprising a protein fortifier as specified in feature b) of the kit of parts according to the present invention. The present invention relates in particular to a unit dose comprising the present protein fortifier which comprises at least 50% protein based on total calories of the protein fortifier and at least 50 wt % protein based on dry weight of the protein fortifier. In a preferred embodiment of the invention the protein fortifier is present in a container, preferably being in unit dose form, and is in dry form, preferably in the form of a powder, and is present in an amount of from 0.05 to 500 g, preferably 0.05 to 400 g, preferably 0.05 to 300 g, preferably 0.05 to 200 g, particularly 0.05 to 10 g, particularly 0.05 to 20 g, particularly 0.05 to 30 g, particularly 0.05 to 40 g, particularly 0.05 to 50 g, particularly 0.05 to 60 g, particularly 0.05 to 70 g, particularly 0.05 to 80 g, particularly 0.05 to 90 g or particularly 0.05 to 100 g, preferably 0.05 g to about 8 g powder based on dry weight per container, wherein the container is packaged with instructions for adding at least a portion of said fortifier to an infant nutritional composition, preferably a preterm infant formula or human milk.

The present invention relates also to a container comprising a protein fortifier as specified in feature b) of the kit of parts according to the present invention, wherein the protein fortifier is present in a container, preferably being in unit dose form, and is in the form of a liquid, preferably sterilized liquid, with a volume of about 0.5 to 70 ml, 0.5 to 60 ml, 0.5 to 50 ml, 0.5 to 40 ml, 1 to 30 ml, preferably 0.5 ml to 20 ml and a protein concentration of at least 0.05 g/ml, more preferably at least 0.1 g/ml, more preferably at least 0.2 g/ml, wherein the container is packaged with instructions for adding at least a portion of said protein fortifier to an infant nutritional composition, preferably to a preterm infant formula or human milk.

Preferably, the unit dose comprises a protein fortifier as described in the preferred embodiments of the kit of parts according to the present invention.

Preferably, the container, preferably unit dose, comprises 0.05 to 500 g, preferably 0.05 to 400 g, preferably 0.05 to 300 g, preferably 0.05 to 200 g, particularly 0.05 to 10 g, particularly 0.05 to 20 g, particularly 0.05 to 30 g, particularly 0.05 to 40 g, particularly 0.05 to 50 g, particularly 0.05 to 60 g, particularly 0.05 to 70 g, particularly 0.05 to 80 g, particularly 0.05 to 90 g or particularly 0.05 to 100 g, preferably 0.05 to 8 g powder based on dry weight, more preferably 0.1 to 4 g, even more preferably 0.2 to 1 g. Preferably, the protein fortifier is a reconstitutable powder. A reconstitutable powder is a powder which can be dissolved in an aqueous liquid, such as human milk or infant formula. Powdered protein fortifiers have the advantage that they minimize the volume displacement of preterm infant formula or human milk. Preferably, the dose units are tins or sachets. In a preferred embodiment the powder is pressed to tablets or pills, with the above unit weight. Such pills or tablets may be packed in a box, a blister pack or a dispenser.

Preferably, the protein is present in the form of a concentrated liquid. Preferably, this liquid is sterilized. Use of concentrated sterilized liquid protein reduces the risk of microbial contamination associated with the preparation of an infant feeding. Use of a concentrated liquid avoids a too high dilution of the basic nutritional composition, preferably a preterm infant formula or human milk. Using concentrated liquid allows dosing the amount of protein added to the basic nutritional composition, preferably a preterm infant formula or human milk, more accurately. Preferably, the protein concentration is from 0.04 g/ml to 0.5 g/ml, more preferably from 0.1 g/ml to 0.15 g/ml, even more preferably about 0.2 g/ml. Preferably, the dose units are packaged in ampoules. Preferably, the concentrated liquid is packaged in a dropping bottle. Such bottles may comprise a deformable drop dispenser pipette enabling to dose the protein by adding a certain amount of drops.

### Other Components:

Preferably, the protein fortifier may comprise besides the protein also minor amounts of minerals like calcium, vitamins, and lactose as present in whey protein concentrates, isolates and protein hydrolysates. Preferably, the protein fortifier comprises prebiotics.

Preferably, the kit of parts or the protein fortifier or the basic nutritional formula of the present invention is free of lactose.

### Application Mode of Administration/Dosage Regime

The protein fortifiers of the present invention are compositions that are to be added to infant nutritional compositions, preferably basic nutritional compositions, preferably preterm infant formula or human milk or fortified human milk, in order to supplement the infant nutritional compositions, preferably basic nutritional compositions, with proteins. Preferably, the protein fortifier is present in a container, for instance as unit dose, which can be added to the infant nutritional composition, preferably the basic nutritional composition, mixed and subsequently the fortified infant, preferably basic, nutritional composition is administered to low body weight infants, preferably low, very low and extremely low body weight infants, preferably LBW, VLBW and/or ELBW infant. This administration is enterally and may be orally via a bottle with a teat or by tube feeding.

Preferably, the protein fortifier is administered in a quantity of 0.05 to 8 g dry weight per day, more preferably 0.1 to 4 g dry weight per day.

The present invention relates also to the use of a kit according to the present invention, or a protein fortifier, preferably in form of a unit dose, according to the present invention for the production of a fortified infant nutritional composition, preferably basic nutritional composition, preferably fortified preterm infant formula or fortified human milk, for preterm infants with a low body weight, preferably up to 1800 g, preferably selected from the group consisting of low body weight infants, very low body weight infants and extremely low body weight infants, preferably selected from the group consisting of LBW infants, VLBW infants and ELBW infants, wherein the protein fortifier of a kit according to the present invention or at least a portion of the protein fortifier according to the present invention is added to an infant nutritional composition, preferably basic nutritional composition, preferably a preterm infant formula or human milk, in such an amount that the amount of protein present in the fortified infant nutritional composition, preferably preterm infant formula or fortified human milk, is adapted according to the protein and/or calorie need of the preterm infant, in particular in dependency upon its body weight, and wherein said protein amount preferably is one or more selected from the group consisting of i) 14% to 16% based on total calories for administration to infants with a body weight of <1000 g, ii) 12% to less than 14% based on total calories for administration to infants with a body weight of 1000 to 1800 g and iii) up to 12%, preferably up to 11.9%, based on total calories for administration to infants with a body weight of >1800 to 2500 g. Most preferably, the above-identified group consists of the members i) and ii) only.

According to a preferred embodiment of the invention the fortified infant nutritional composition, preferably fortified preterm infant formula or fortified human milk, is for ii) 12% to 13.9%, even more preferably 12% to 13, 5% based on total calories for administration to infants with a body weight of 1000 to 1800 g.

In a preferred embodiment the invention relates to the use of a kit according to the present invention or of a protein fortifier according to the present invention for the production of a fortified infant nutritional composition, preferably fortified basic nutrition composition, preferably fortified preterm infant formula or fortified human milk, for preterm infants with a low body weight, preferably up to 1800 g, preferably selected from the group consisting of low body weight infants, very low body weight infants and extremely low body weight infants, preferably selected from the group consisting of LBW infants, VLBW infants and ELBW infants, wherein the protein fortifier of a kit according to the present invention or at least a portion of the protein fortifier according to the present invention is added to an infant nutritional composition, preferably basic nutritional composition, preferably a preterm infant formula or human milk, in such an amount that the amount of protein present in the fortified infant nutritional composition, preferably fortified preterm infant formula or fortified human milk, is adapted according to the protein and/or calorie need of the preterm infant, in particular in dependency upon its body weight, and wherein said protein amount preferably is one or more selected from the group consisting of i) 3.6 g to 4.1 g per 100 kcal contained in the fortified nutritional composition for administration to infants with a body weight of <1000 g, ii) 3.2 g to less than 3.6 g per 100 kcal contained in the fortified nutritional composition for administration to infants with a body weight of 1000 to 1800 g and iii) up to 3 g per 100 kcal, more preferably 2.2 g to 2.8 g per 100 kcal, contained in the fortified nutritional composition for administration to infants with a body weight of >1800 to 2500 g. Most preferably, the above-identified group consists of the members i) and ii) only.

According to a preferred embodiment of the invention the concentration of the protein present in the fortified infant nutritional composition, preferably fortified preterm infant formula or fortified human milk, is for ii) 3.2 g to 3.59 g, even more preferably 3.2 g to 3.5 g, per 100 kcal contained in the fortified nutritional composition for administration to infants with a body weight of 1000 to 1800 g.

The present invention relates also to a method of feeding preterm infants, with a low body weight, preferably up to 1800 g, preferably selected from the group consisting of low body weight infants, very low body weight infants and extremely low body weight infants, preferably selected from the group consisting of LBW infants, VLBW infants and ELBW infants, comprising the steps of: xa) fortifying an infant nutritional composition, preferably a preterm infant formula, preferably a synthetic preterm infant formula or human milk, or human milk fortified with standard human milk fortifier, with protein by adding to it the protein fortifier of the present invention or at least a portion of the protein fortifier according to the present invention, and xb) administering to said infant the fortified infant nutritional composition, preferably the fortified preterm infant formula or fortified human milk, obtained in step xa), wherein preferably the protein fortifier is added to the infant nutritional composition, preferably the preterm infant formula or human milk, in such an amount that the amount of protein present in the fortified infant nutritional composition, preferably the fortified preterm infant formula or fortified human milk, is adapted according to the protein and/or calorie need of the preterm infant, in particular in dependency upon its body weight, and wherein said protein amount preferably is one or more selected from the group consisting of i) 14% to 16% based on total calories for administration to infants with a body weight of <1000 g, ii) 12% to less than 14% based on total calories for administration to infants with a body weight of 1000 to 1800 g and iii) up to 12%, preferably up to 11.9%, based on total calories for administration to infants with a body weight of >1800 to 2500 g. Most preferably, the above-identified group consists of the members i) and ii) only.

According to a preferred embodiment of the invention the protein fortifier is added to the infant nutritional composition, particularly the preterm infant formula or human milk, in such an amount that the amount of protein present in the fortified infant nutritional composition, preferably the fortified preterm infant formula or fortified human milk, is for ii) 12% to 13.9%, even more preferably 12% to 13.5% based on total calories when administered to infants with a body weight of 1000 to 1800 g.

Preferably, the fortified infant nutritional composition, preferably the fortified preterm infant formula or fortified human milk, prepared using a kit or protein fortifier of the present invention for said purpose or used in a method of the present invention is administered to a preterm infant selected from the group consisting of low body weight infants, very low body weight infants and extremely low body weight infants, preferably selected from the group consisting of a LBW, a VLBW or an ELBW infant, in such an amount that the amount of protein administered is adapted according to the protein and/or calorie need of the preterm infant, in particular in dependency upon its body weight, preferably is one or more selected from the group consisting of

i) 4.0 to 4.5 g protein per kg body weight per day for administration to infants with a body weight of <1000 g,

ii) 3.5 to less than 4.0 g, preferably to 3.9 g, protein per kg body weight per day for administration to infants with a body weight of 1000 to 1800 g and

iii) 2.0 to 3.4 g protein per kg body weight per day for administration to infants with a body weight of more than 1800 to 2500 g. Most preferably, the above-identified group consists of the members i) and ii) only.

Preferably, the fortified infant nutritional composition, preferably the fortified preterm infant formula or fortified human milk, prepared using a kit or protein fortifier of the present invention for said purpose or used in a method of the present invention is administered to a preterm infant selected from the group consisting of low body weight infants, very low body weight infants and extremely low body weight infants, preferably selected from the group consisting of a LBW, a VLBW or an ELBW infant, in such an amount that the amount of protein administered is adapted according to the protein and/or calorie need of the preterm infant, in particular in dependency upon its body weight, preferably is one or more selected from the group consisting of i) 3.6 g to 4.1 g per 100 kcal contained in the fortified nutritional composition for administration to infants with a body weight of <1000 g, ii) 3.2 g to less than 3.6 g per 100 kcal contained in the fortified nutritional composition for administration to infants with a body weight of 1000 to 1800 g and iii) up to 3 g per 100 kcal contained in the fortified nutritional composition, more preferably 2.2 g to 2.8 g per 100 kcal contained in the fortified nutritional composition for administration to infants with a body weight of >1800 to 2500 g. Most preferably, the above-identified group consists of the members i) and ii) only.

According to a preferred embodiment of the invention the concentration of the protein present in the fortified infant nutritional composition, preferably the fortified preterm infant formula or fortified human milk, is for ii) 3.2 g to 3.59 g, even more preferably 3.2 g to 3.5 g, per 100 kcal contained in the fortified nutritional composition for administration to infants with a body weight of 1000 to 1800 g.

The methods, uses, protein fortifiers and kits according to the present invention also comprise embodiments, wherein the protein fortifier together with an infant nutritional composition, that means the fortified infant nutritional composition, preferably the fortified preterm infant formula or fortified human milk, is administered to preterm infants in such an amount that the amount of protein administered is adapted according to the protein and/or calorie need of the preterm infant, in particular in dependency upon its body weight, and wherein said protein amount preferably is one or more selected from the group consisting of x) 4.0 to 4.5 g protein per kg body weight per day for administration to infants with a body weight of 500 to 1200 g and xi) 3.9 to 3.8 g protein per kg body weight per day for administration to infants with a body weight of 1201 to 1500 g and xii) 3.7 to 3.5 g protein per kg body weight per day for administration to infants with a body weight of more than 1500, e. g. 1501, to 1800 g.

The methods, uses, protein fortifier and kits according to the present invention also comprise embodiments, wherein the protein fortifier together with the infant nutritional composition, that means the fortified infant nutritional composition, preferably the fortified preterm infant formula or fortified human milk, is administered to preterm infants in such an amount that the amount of total calories administered which is adapted according to the protein and/or calorie need of the preterm infant, in particular in dependency upon its body weight, and wherein said calorie amount preferably is one or more selected from the group consisting of xiii) 103 to 106 kcal per kg body weight per day for administration to infants with a body weight of 500 to 700 g, xiv) 107 to 112 kcal per kg body weight per day for administration to infants with a body weight of 701 to 900 g, xv) 113 to 122 kcal per kg body weight per day for administration to infants with a body weight of 901 to 1200 g, xvi) 123 to 127 kcal per kg body weight per day for administration to infants with a body weight of 1201 to 1500 g and xvii) 128 to 132 kcal per kg body weight per day for administration to infants with a body weight of 1501 to 1800 g.

The methods and uses of the present invention are preferably non-therapeutic methods and uses. In a furthermore preferred embodiment of the present invention the methods and uses of the present invention are therapeutic methods and uses.

Further preferred embodiments are the subject matter of subclaims.

The invention is described in more detail by way of the following examples.

### EXAMPLE 1

### Preterm Formula Supplement—Protein Fortifier

A protein fortifier comprising 20 g protein per 100 ml; 80 kcal protein/100 ml was provided. The composition comprises about 85% protein based on dry weight of the composition and about 90% based on total calories. The protein composition comprises about 0.12 g/ml hydrolysed whey protein (e. g. from Arla or Fonterra) and about 0.08 g/ml hydrolysed casein (e. g from DMV or Fonterra). Due to the commercial product used, in addition to protein small amounts (<10%) of minerals, vitamins, lactose, and fat) are present.

The protein is packed as a volume of 1 ml in ampoules. The protein composition is sterilized.

### EXAMPLE 2

### Protein Administered in Range of Reconstituted Preterm Formulae Using Varying Amounts of Preterm Formula Supplement

A standard commercially available preterm formula (Aptamil, Pre-matil) (comprising 3.1 g protein per 100 kcal, 2.5 g protein per 100 ml; and 80 kcal/100 ml) was used. This formula was supplemented with either 4 ml, 3 ml and 2 ml per 100 ml of the preterm formula supplement of example 1, resulting in addition of 0.8, 0.6 and 0.4 g protein to 100 ml resulting in 104, 103 and 102 ml supplemented formula respectively.

The protein intake of LBW, VLBW and ELBW infants when administered this range of (fortified) preterm infant formulae dependent on body weight is calculated and compared with the protein intake when prior art preterm infant formula are administered, assuming that the recommended daily intake of calories is administered. The results are compared with the theoretical recommended daily intake and shown in the table.

TABLE
Protein intake of LBW, VLBW and ELBW infants when administered
a preterm infant formulae fortified with the protein supplement
of the present invention.

| | | | | | Protein | |
|---|---|---|---|---|---|---|
| | | | | | provided | |
| | | | | | with | |
| | | | | | preterm | |
| | | | Caloric | Protein | infant | |
| | | Protein | need | provided | formula | Protein |
| | | need | Kcal/ | (prior art²) | alone | provided |
| Body weight | | g/kg/day¹ | g/day¹ | (g/kg/day) | (g/kg/day) | g/kg/day |
| 500-700 | g | 4 | 105 | 3.8 | 3.3 | 4.0³ |
| 700-900 | g | 4 | 108 | 3.9 | 3.3 | 4.0⁴ |
| 900-1200 | g | 4 | 119 | 4.3 | 3.7 | 4.2⁵ |
| 1200-1500 | g | 3.9 | 127 | 4.3 | 3.9 | 3.9 |
| 1500-1800 | g | 3.6 | 128 | 4.6 | 4.0 | 4.0 |

¹Ziegler & Carlson, 2009, J. Matern. Fetal Neonat Med. 22(3): 191-197
²Prior art solution: 2.88 g protein/100 ml, 3.6 g protein per 100 kcal. 80 kcal/100 ml
³Preterm infant formula supplemented with 0.8 g protein/100 ml
⁴Preterm infant formula supplemented with 0.6 g protein/100 ml
⁵Preterm infant formula supplemented with 0.4 g protein/100 ml

From the calculations shown in table 1 it can be deduced that fortifying an existing preterm infant formula with the present protein supplement results in a most optimal supply of protein in LBW, VLBW and ELBW infant.

### EXAMPLE 3

### Protein Supplement (Fortifier) for Use in Supplementing Human Milk or Standard HMF Fortified Human Milk

Expressed human milk is fortified with standard HMF.

The standard HMF is a powdered composition in sachets with a con-tent of 2.2 g. It comprises per 100 g powder 25.2 g protein (whey protein and casein in a 1/1 wt ratio), and 62.2 g digestible carbohydrates, the rest being minerals, in particular calcium and phosphate, trace elements and vitamins. The amount of protein is 29% based on total calories. The HMF is added to the human milk in an amount of 4.4 g per 100 ml. This standard HMF fortified human milk is then supplemented with either 2 ml or 1 ml per 100 ml of the preterm formula supplement of example 1, resulting in addition of 0.4, and 0.2 g protein to 100 ml resulting in 102, and 101 ml supplemented formula respectively.

The HMF fortified human milk is intended for preterm infants with a body weight of 1800 to 2500.

The HMF fortified human milk to which 1 ml per 100 ml of the protein supplement is added is intended for infants with a body weight of 1000 to 1800 g.

The HMF fortified human milk to which 2 ml per 100 ml of the protein supplement is added is intended for infants with a body weight of less than 1000 g.

The protein supplement is provided with instructions on how the HMF fortified human milk should be fortified with the protein fortifier based on body weight.

### EXAMPLE 4

Powdered protein supplement comprising per 100 g powder 82.1 g protein (whey protein and casein in a 1/1 weight ratio), 2.2 g carbohydrate, 0.1 g fat. The remainder of the supplement is made up by minerals, trace elements and vitamins. Based on total energy the protein provides 97%.

The supplement is packed is sachets under a protected atmosphere in amounts of 2.4 g. The following indications are provided together with the package:

“The protein supplement should be added to HMF fortified breast milk or to preterm formula. Supplementation is done to achieve a protein level which covers the need of extremely low birth weight infants in order to ensure a good growth and development.

For preterm babies <1000 g a protein intake of 3.6-4.1 g/100 kcal (4.0-4.5 g/kg/d) is recommended.

If human milk is used:

Add breast milk fortifier according to instruction. As guide the protein content of preterm breast milk is 1.5 g/100 ml (2.3 g/100 kcal). Then add the appropriate amount of protein supplement to achieve the recommended level of protein of 3.6-4.1 g/100 kcal.

If preterm formula is used:

A preterm 1 formula contains 3.3 g protein/100 kcal (2.6 g/100 ml). To adjust the protein level to meet the recommendation for low birth weight babies which protein requirements are not met by standard feeding solutions 0.4 g to 0.9 g protein supplement per 100 ml pre-term formula needs to be added.”

1. A kit of parts for use in providing a protein and/or calorie adapted body weight dependent nutrition to preterm infants comprising
a) a basic nutritional composition and
b) a protein fortifier which comprises at least 50% protein based on total calories of the protein fortifier and at least 50 wt % protein based on dry weight of the protein fortifier.

2. The kit according to claim 1, wherein the infants are selected from the group consisting of low body weight infants, very low body weight infants and extremely low body weight infants.

3. The kit of claim 1 or 2, wherein the basic nutritional composition is a human milk, fortified human milk or a preterm infant formula.

4. The kit according to anyone of the preceding claims, wherein the protein fortifier comprises casein and whey protein.

5. The kit according to any one of the preceding claims, wherein the protein fortifier comprises a protein with a degree of hydrolysis from 3 to 20%.

6. The kit according to any one of the preceding claims, wherein the protein fortifier, the basic nutritional composition or both is or are present in form of a unit dose.

7. The kit according to any one of the preceding claims, wherein the kit comprises additionally c) instructions for adding at least a portion of the protein fortifier to the basic nutritional composition.

8. The kit according to claim 7, wherein the instructions comprise instructions to add the protein fortifier to the basic nutritional composition in such an amount that the amount of protein present in the fortified nutritional composition is one or more selected from the group consisting of:
i) 14% to 16% based on total calories for administration to infants with a body weight of <1000 g,
ii) 12% to less than 14% based on total calories for administration to infants with a body weight of 1000 to 1800 g and
iii) up to 12% based on total calories for administration to infants with a body weight of >1800 to 2500 g.

9. The kit according to claim 7 or 8, wherein the instructions comprise instructions to add the protein fortifier to the basic nutritional composition in such an amount that the amount of protein to be administered to the preterm infant is one or more selected from the group consisting of i) 4.0 to 4.5 g protein per kg body weight per day for administration to infants with a body weight of <1000 g, ii) 3.5 to less than 4.0 g protein per kg body weight per day for administration to infants with a body weight of 1000 to 1800 g and iii) 2.0 to 3.4 g protein per kg body weight per day for administration to infants with a body weight of more than 1800 to 2500 g.

10. A protein fortifier for use in providing in combination with an infant nutritional composition a protein and/or calorie adapted body weight dependent nutrition to preterm infants, wherein the protein fortifier comprises at least 50% protein based on total calories of the protein fortifier and at least 50 wt % protein based on dry weight of the protein fortifier.

11. The protein fortifier of claim 10, wherein the infant nutritional composition is a basic nutritional composition.

12. A container comprising a protein fortifier as specified in feature b) of anyone of claims 1 to 9 which is in the form of a powder and is present in an amount of from 0.05 g to 500 g per container, wherein the container comprises instructions for adding at least a portion of said protein fortifier to an infant nutritional composition, preferably a preterm infant formula or human milk.

13. A container comprising a protein fortifier as specified in feature b) of anyone of claims 1 to 9, wherein the protein fortifier is present in form of a powder or in the form of a sterilized liquid with a volume of 0.5 ml to 70 ml and a protein concentration of at least 0.05 g/ml, more preferably at least 0.1 g/ml, wherein the container comprises instructions for adding at least a portion of said protein fortifier to an infant nutritional composition, preferably preterm infant formula or human milk.

14. Use of a kit according to claims 1 to 9 or of a protein fortifier of claim 10 or 11 for the production of a fortified infant nutritional composition for preterm infants, wherein the protein fortifier as specified in feature b) in anyone of claims 1 to 9 or the protein fortifier according to claim 10 or 11 is added to an infant nutritional composition in such an amount that the amount of protein present in the fortified infant nutritional composition is one or more selected from the group consisting of:
i) 14% to 16% based on total calories for administration to infants with a body weight of <1000 g,
ii) 12% to less than 14% based on total calories for administration to infants with a body weight of 1000 to 1800 g and
iii) up to 12% based on total calories for administration to infants with a body weight of >1800 to 2500 g.

15. The use according to claim 14, wherein the fortified infant nutritional composition is for administration to said preterm infant in such an amount that the amount of protein administered is one or more selected from the group consisting of: i) 4.0 to 4.5 g protein per kg body weight per day for administration to infants with a body weight of <1000 g, ii) 3.5 to less than 4.0 g protein per kg body weight per day for administration to infants with a body weight of 1000 to 1800 g and iii) 2.0 to 3.4 g protein per kg body weight per day for administration to infants with a body weight of more than 1800 to 2500 g.

16. A method of feeding preterm infants, preferably selected from the group consisting of low body weight infants, very low body weight infants and extremely low body weight infants, comprising the steps of:
xa) fortifying an infant nutritional composition with protein by adding to it the protein fortifier specified in feature b) in any one of claims 1 to 9 or the protein fortifier of claim 10 or 11 and
xb) administering to said infant the fortified infant nutritional composition obtained in step xa),
wherein the protein fortifier is added to the infant nutritional composition in such an amount that the amount of protein present in the fortified infant nutritional composition is one or more selected from the group consisting of:
i) 14% to 16% based on total calories for administration to infants with a body weight of <1000 g,
ii) 12% to less than 14% based on total calories for administration to infants with a body weight of 1000 to 1800 g and
iii) up to 12% based on total calories for administration to infants with a body weight of >1800 to 2500 g.

17. The method of feeding preterm infants according to claim 16, wherein the fortified infant nutritional composition is administered to said infant in such an amount that the amount of protein administered is one or more selected from the group consisting of:
4.0 to 4.5 g protein per kg body weight per day for administration to infants with a body weight of <1000 g,
ii) 3.5 to less than 4.0 g protein per kg body weight per day for administration to infants with a body weight of 1000 to 1800 g and
iii) 2.0 to 3.4 g protein per kg body weight per day for administration to infants with a body weight of more than 1800 to 2500 g.

18. The use according to claim 14 or 15 or the method according to claim 16 or 17, wherein the infant nutritional composition is a human milk, fortified human milk or a preterm infant formula.
